(19) United States
(12) Patent Application Publication
(10) Pub. No.: US 2011/0272650 A1
(43) Pub. Date: Nov. 10, 2011

(54) Lifting and Moving Device

(76) Inventor: Jerry Behar, Amherst, NY (US)

(21) Appl. No.: 12/949,079

(22) Filed: Nov. 18, 2010

Related U.S. Application Data
(60) Provisional application No. 61/343,918, filed on May 6, 2010.

(51) Int. Cl. B65G 7/00

(52) U.S. Cl. 254/127

(57) ABSTRACT

A lifting and moving device for assisting a user in applying a force to an implement to move a load. In the practice of the invention, the user moves the load, at least in part, by leaning or shifting their weight. One embodiment of the device includes a bar having a first end and a second end. A bracket is pivotally attached to the bar. The bracket is capable of being coupled to the implement. The first end of the bar acts as a fulcrum for the implement. A strap is attached to the bar and also coupled to the user. Movement of the user, such as by leaning or shifting of their weight, places the strap under tension and provides a force for moving the load. The bar, the strap, the leg, and a foot plate form a four bar linkage that is combined with the Class 1 lever.

### CROSS-REFERENCE TO RELATED APPLICATION

This invention claims priority benefit of U.S. Provisional Patent Application No. 61/343,918 filed on May 6, 2010, which is entitled “Leanlever-lifting and moving device” which is incorporated herein by reference.

### BACKGROUND OF INVENTION

During lifting, moving or pulling of heavy loads, or otherwise applying force to an implement or tool, an individual may experience stress on their back that may lead to discomfort or injury. The stress on the back of the individual may be caused by many factors including, but not limited to, improper technique, repetitive motion, size or distribution of the load, and shape of the implement or tool being used.

Accordingly, there is a need for a device for use with implements or tools that provides a mechanical advantage and reduces stress on the back of the user to enable individuals to lift, move or pull heavier loads with a reduced risk of injury.

### SUMMARY OF INVENTION

The present invention meets the above-described need by providing a lifting and moving device for assisting a user in applying a force to an implement to move a load. In the practice of the invention, the user moves the load, at least in part, by leaning or shifting their weight. One embodiment of the device includes a bar having a first end and a second end. A bracket is pivotally attached to the bar. The bracket is capable of being coupled to the implement. The first end of the bar acts as a fulcrum for the implement to establish a Class 1 lever. A strap is attached to the bar and also coupled to the user. Movement of the user, such as by leaning or shifting of their weight, places the strap under tension and provides a force for moving the load. The bar, the strap, the leg, and a foot plate form a four bar linkage (best shown in FIG. 11) that combines with the Class 1 lever to provide a mechanical advantage that significantly reduces the stress on the back when lifting or moving loads with an implement or tool.

In another embodiment of the invention, a lifting and moving device for assisting a user in applying a force to a tool having an elongate handle is provided. The device includes a bar having a first end and a second end. A hinge has a first leaf and a second leaf connected by a pivot pin. The first leaf of the hinge is attached to the first end of the bar. A bracket is rotatably attached to the second leaf of the hinge. The bracket is configured to receive the handle of the tool. The device provides a mechanical advantage and provides for dumping a load carried by the tool without lifting.

In another embodiment of the invention, a lifting and moving device for assisting a user in applying a force to a tool having an elongate handle is provided. The device includes a a bar having a first end and a second end. A foot plate extends from the second end of the bar. A hinge has a first leaf and a second leaf connected by a pivot pin. The first leaf is attached to the first end of the bar. A bracket is rotatably attached to the second leaf of the hinge. The bracket is configured to attach around the handle of the tool. A strap has a first portion attached to the device and has a second portion capable of being coupled to the user. The hinge is rotatable relative to the tool between a first position where the pivot pin is generally perpendicular to a longitudinal axis of the handle and a second position where the pivot pin is generally parallel to a longitudinal axis of the handle. The device provides a mechanical advantage by combining a four bar linkage with a Class 1 lever.

The present invention also includes a method of assisting a user of an implement in lifting and moving a load. The first step of the method is providing a bar having a first end and a second end. Next, a bracket is pivotally supported by the first end of the bar. The bracket is capable of being coupled to the implement. In the next step, a strap having a first portion attached to the device and having a second portion capable of being coupled to the user is provided. Next, the implement is coupled to the bracket such that the bar establishes a fulcrum for the implement to form a class 1 lever. Then a force is applied to the implement on a side of the fulcrum opposite from the load. And in the next step, the strap is placed in tension to provide an additional force for moving the load.

### BRIEF DESCRIPTION OF THE DRAWINGS

The invention is illustrated in the drawings in which like reference characters designate the same or similar parts throughout the figures of which:

FIG. 1 is a perspective view of one embodiment of the device of the present invention attached to a long handled tool;

FIG. 2 is a perspective view of the device attached to a long handled shovel with the blade of the shovel supporting a load;

FIG. 3a is an enlarged perspective view of the bar of the present invention with a hinge, bracket and foot plate attached thereto;

FIG. 3b is a partial elevational view showing the bracket of the present invention rotatably attached to the second leaf of the hinge;

FIG. 4a is a plan view of the bar of the present invention;

FIG. 4b is a side view of the bar shown in FIG. 4a;

FIG. 4c is a plan view of the first end of the bar;

FIG. 5 is a plan view of one embodiment of the hinge of the present invention;

FIG. 6 is an elevational view showing one embodiment of the bracket of the present invention;

FIG. 7a is a plan view of one embodiment of the foot plate of the present invention;

FIG. 7b is a perspective view of another embodiment of the foot plate;

FIG. 8a is a plan view of one embodiment of the strap of the present invention;

FIG. 8b is a perspective view of the device of the present invention with the strap attached to the bracket;

FIG. 8c is a perspective view of an alternate embodiment of the invention with the strap disposed through the bracket and connecting at a lower portion of the implement;

FIG. 9 is a side elevational view of one embodiment of the knob of the present invention;

FIG. 10 is a perspective view of the device of the present invention;

FIG. 11 is a schematic diagram of the combination of a four bar linkage and a Class 1 lever system which is incorporated in the present invention;

FIG. 12 is a perspective view of the device of the present invention in use with a different implement;

FIG. 13 is a perspective view of the device of the present invention with a strap having a pair of hooks for attaching to a load;

FIG. 14 is a perspective view of the device of the present invention with a strap forming a closed end loop; and

FIG. 15 is a perspective view of the device of the present invention free standing and supporting a load.

### DETAILED DESCRIPTION OF THE INVENTION

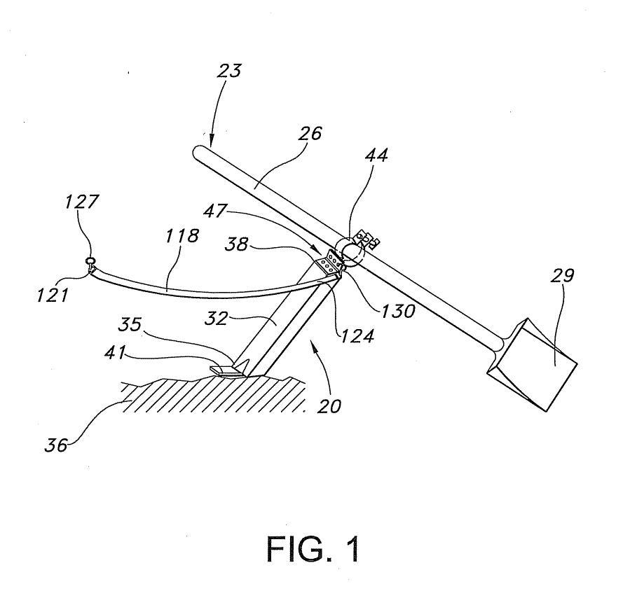

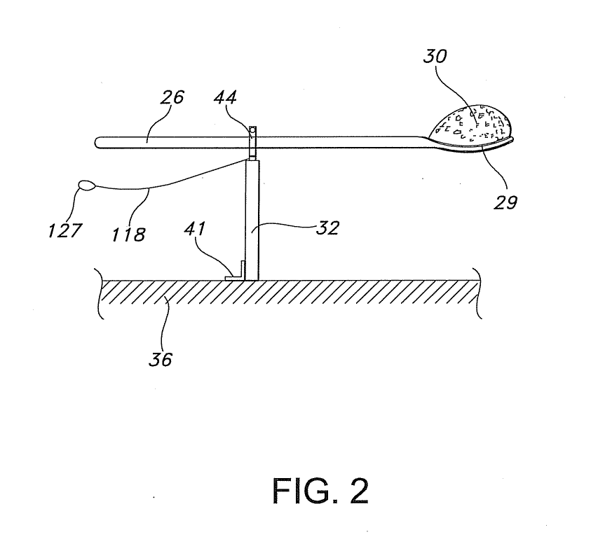

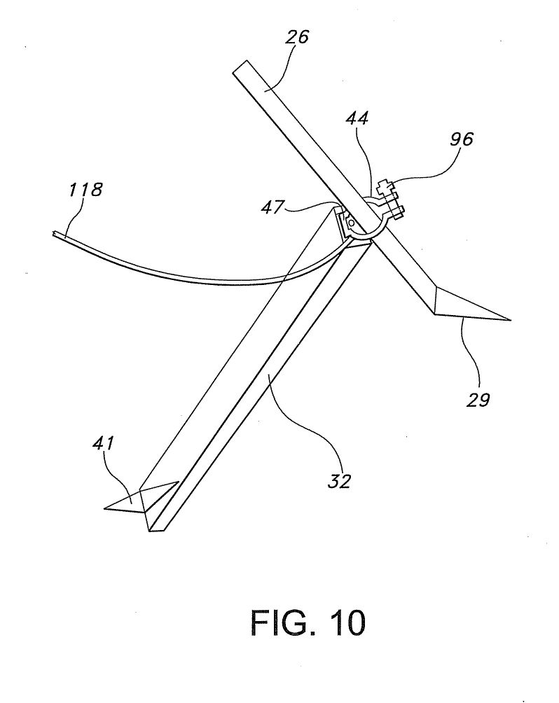

Referring generally to FIGS. 1-15 and initially turning to FIG. 1, the device 20 of the present invention is shown in connection with a shovel 23 having an elongate handle 26. The handle 26 extends to the blade 29 of the shovel 23. The shovel 23 may be used to excavate, lift, and move a load 30 (FIG. 2). The shovel 23 is one example of a tool that the device 20 of the present invention can be used with. The device 20 may also be used with other implements and tools including, but not limited to, other long handled tools, power tools, and the like.

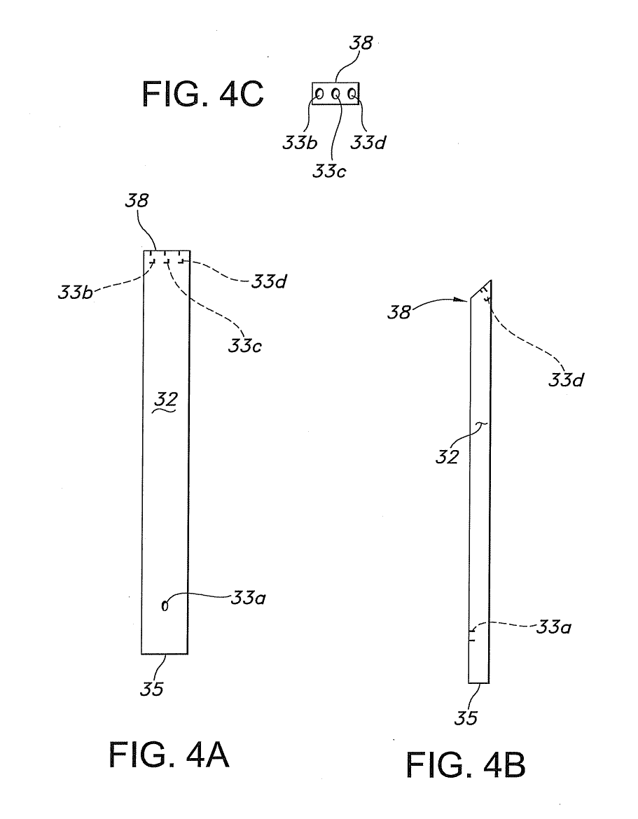

The device 20 includes a bar 32 having a first end 35 and a second end 38 opposite the first end 35. The bar 32 may be constructed of any suitable material capable of supporting the load at the second end 38 when the device 20 is attached to an implement or tool. The bar 32 may also be provided with structure for dampening vibrations or stability when the device 20 is used with power equipment. The first end 35 is supported by the ground 36, and may be provided with a foot plate 41 which is described in greater detail herein. The second end 38 of the bar 32 establishes the fulcrum point for a Class 1 lever that is established by coupling the bar 32 to the shovel 23 as shown. As shown in FIGS. 4a-4c, the bar 32 may be provided with a solid rectangular cross-section. The rectangular cross-section provides a wider footprint that enhances the stability of the device during operation. Other shapes and profiles may also be suitable depending on the materials of construction. For example, the bar 32 may be tubular or channel-shaped or wider at certain points or may be extendable. The example shown is solid with pre-drilled holes 33a-33d for receiving the fastening members for attaching the hinge 47 and foot plate 41. As an alternative, the hinge 47 could be attached by other means as described below.

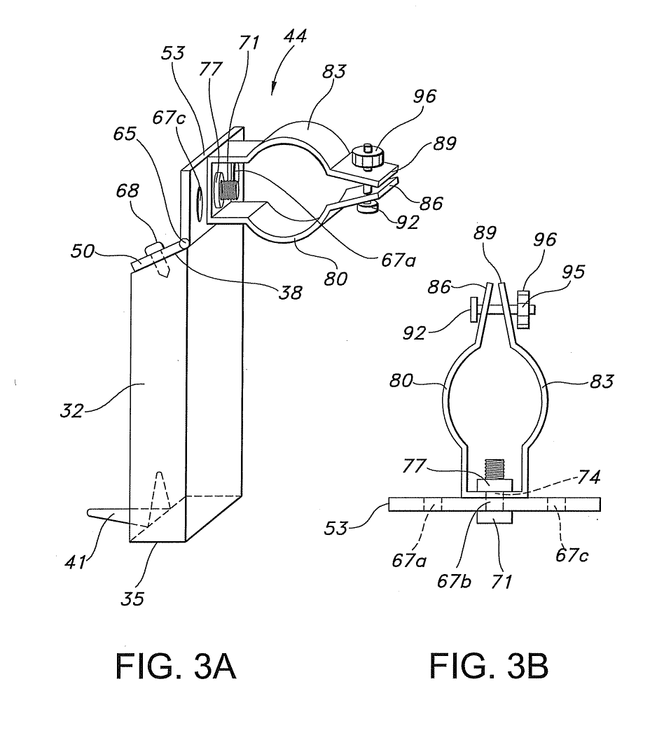

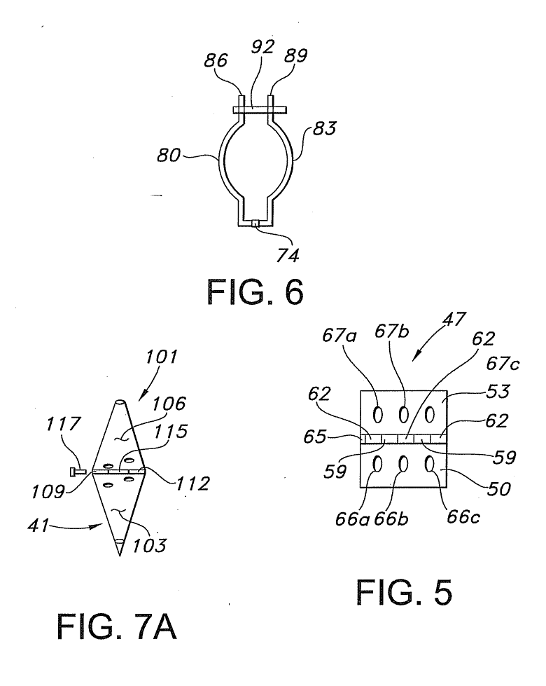

A bracket 44 is pivotally attached to the second end 38 of the bar 32 by means of a hinge 47. As best shown in FIG. 5, the hinge 47 may comprise a butt-type with a first leaf 50 and a second leaf 53. The first leaf 50 has knuckles 59 extending therefrom and the second leaf 53 has knuckles 62 extending therefrom. The knuckles 59 and 62 are capable of being aligned to receive a pivot pin 65 such that the two leaves 50, 53 form the hinge 47 as will be evident to those of ordinary skill in the art based on this disclosure. The first leaf 50 may be provided with openings 66a, 66b, and 66c, and the second leaf 53 may be provided with openings 67a, 67b, and 67c. As best shown in FIG. 3a, the first leaf 50 is fixedly attached to the second end 38 of the bar 32 by means of screws 68. The pivot pin 65 is placed on the edge of the width of the bar 32 and the second leaf 53 is allowed to rotate outward. Other fastening members or materials such as rivets, nails, adhesives, or the like may also be used. Also, the hinge 47 may be attached to the bar 32 by welding. As an alternative, half of the hinge 47 could also be integrally formed in the second end 38 of the bar 32. This embodiment of the invention is shown with a butt-type hinge, however, the invention is not intended to be limited to a specific hinge and other mechanical hinges and hinge-like arrangements such as “living hinges” or the like may also be suitable for allowing for pivoting motion of the bracket 44 relative to the bar 32.

In FIG. 3b, the second leaf 53 of the hinge 47 is connected to the bracket 44. The bracket 44 may be rotatably attached to the second leaf 53 of the hinge 47. The bracket 44 may be rotatably attached to the second leaf 53 by means of a bolt 71 with a nut 77 attached thereto. The bracket 44 is capable of rotating freely in either direction about the longitudinal axis of the bolt 71. The bottom of the bracket 44 has an opening 74 for receiving the bolt 71. The bolt 71 may extend through opening 67b in the second leaf 53 and then extend through the opening 74 where it receives a nut 77. This embodiment is one example of rotatably mounting the bracket 44 to the second leaf 53. It will be evident to those of ordinary skill in the art based on this disclosure that rotation of the bracket relative to the second leaf 53 may also be accomplished by other means including bearings or the like.

Turning to FIG. 6, the bracket 44 is a clam-shell type bracket with a pair of arms 80 and 83 that extend opposite each other and may be connected at their distal ends 86, 89. A bolt 92 extends through the distal ends 86, 89 of the bracket 44. A nut 95 on the bolt 92 can be used to bring the distal ends 86, 89 together to tighten the bracket 44 around the handle 23 of the shovel 26. A knob 96 can be mounted to the nut 95 to provide for tightening the bracket 44 around the handle 23. The bracket 44 shown in this embodiment is one example of a bracket suitable for use with the invention. Depending on the implement or tool that the device 20 is being used with, the shape of the bracket 44 may change to accommodate different structures or locking mechanisms to the tool or implement. The clam-shell type bracket shown is an example of a bracket for use with a long handled tool, and the invention is not intended to be limited to any particular bracket. Other brackets could also be substituted for use with other implements as will be evident to those of ordinary skill in the art based on this disclosure. Alternatively, depending on the shape of the implement or tool, it could be attached directly to the second leaf 53 of the hinge 47 without requiring a bracket for mounting.

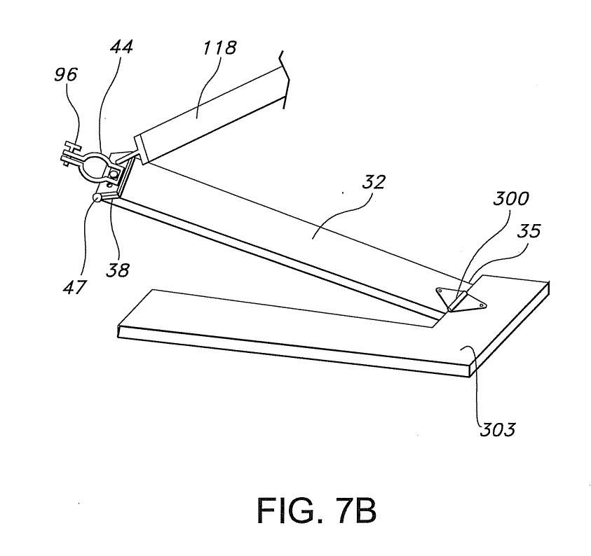

The foot plate 41 (best shown in FIG. 7a) may be formed from the free end of a hinge 101. The hinge 101 has two leaves 103, 106 with one leaf 103 having two knuckles 109, 112 and the other leaf 106 having one knuckle 115. The knuckles 109, 112, and 115 are aligned and a pivot pin 117 is inserted to form the hinge 101. The hinge type foot plate 41 is designed to be convenient for folding the foot plate 41 upward parallel to the bar 32 when the device 20 is not in use. Other types of foot plates could also be used included foot plates attached or integrally formed in the bar 32. When the user exerts a force against the foot plate 41, the bar 32 is prevented from rotating as will be described in greater detail herein. The foot plate may extend in any direction in order to provide for greater stability and to prevent lateral movement. For example, as shown in FIG. 7b a hinge 300 may be attached to an L-shaped base 303. Other shapes would also be suitable as will be evident to those of ordinary skill in the art based on this disclosure.

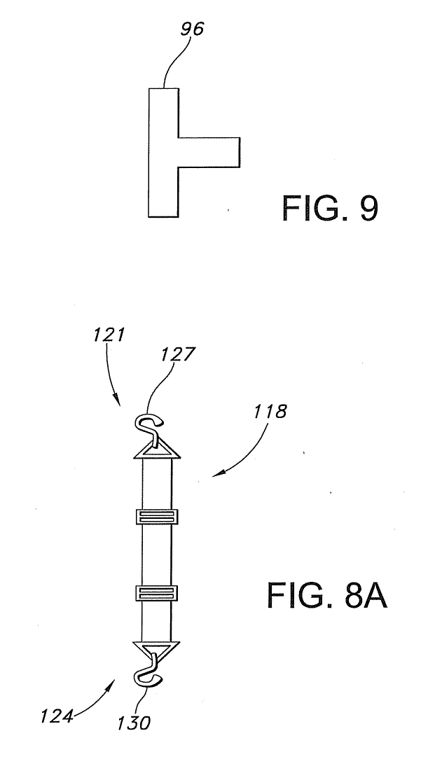

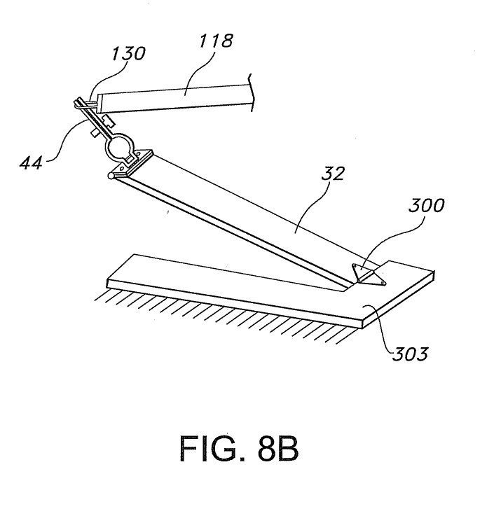

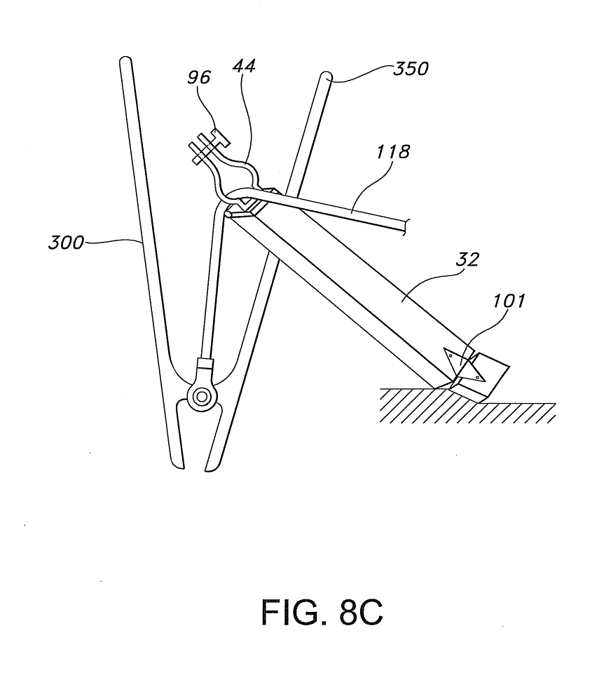

A strap 118 (best shown in FIG. 8a) may be attached to the device 20. The strap 118 has a first end 121 and a second end 124. The ends 121, 124 may be provided with hooks 127 and 130, respectively. The hook 127 can be used to attach to a belt of the user. Also, the strap 118 can be wrapped around the trunk or lower body of the user and attached to itself. The other hook 130 may be attached to the device 20 or to the implement or tool itself as will be described in greater detail below. The hook 130 may be attached through the opening 67c in the second leaf 53 of the hinge 47. As shown in FIG. 8b, the hook 130 may also be attached to the bracket 44. Turning to FIG. 8c, the strap 118 also may extend through the center of the bracket 44 and attach to the bottom of a post hole digging tool 350. As will be evident to those of ordinary skill in the art based on this disclosure, the strap 118 could also be attached to other implements or tools or at other locations on the implement. The strap 118 completes a second mechanical system (four bar linkage) to assist in lifting and moving the load at the end of the shovel 23 as will be described in greater detail herein.

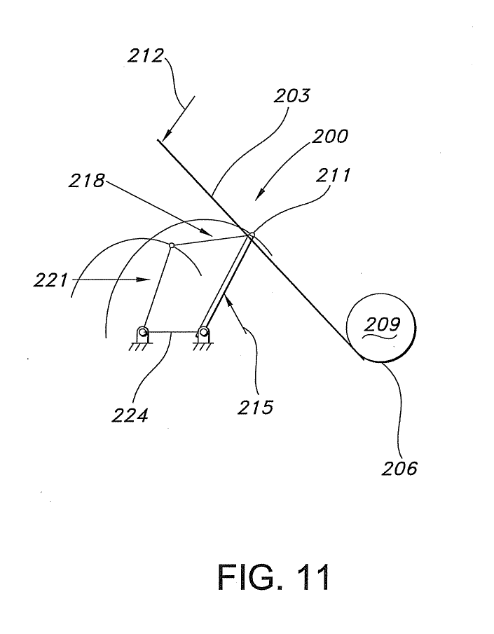

Turning to FIG. 11, a schematic diagram illustrates the theory of operation of the device 20 of the present invention. A tool 200 having an elongate handle 203 and a blade 206 is shown in a position where the blade 206 is engaging a load 209. The bar 32 establishes a fulcrum point 211 between a force indicated by arrow 212 and the load 209. In addition to the Class 1 lever, a four bar linkage is formed. The bar 32 forms a first link 215. The strap 118 forms a second link 218. The leg of the user forms a third link 221, and the foot plate 41 forms the fixed link 224. Accordingly, in use the device 20 of the present invention combines a four bar linkage to a Class 1 lever to provide for mechanical advantage and reduce the stress on the back of the user when lift or moving a load 209. By means of the strap 118 which completes the four bar linkage, the user can apply additional force to the load 209 by simply shifting their weight to place the strap 118 under tension or by moving backward away from the load to place the strap 118 under tension.

In use, the device 20 is attached to the tool or implement and the strap 118 is attached or wrapped around the user's trunk or lower body. With the strap 118 under tension, the user places the bar 32 on the ground 36 and scoops the load 30 using the blade 29 of the shovel 23. The user then places his foot on the foot plate 41 to secure the bar 32 in place. The user then leans or twists or shifts his weight backward to lift the load 30 while holding the end of the shovel 23 in place. Tension on the strap 118 aids the lever action, and the user lifts the load 30. During lifting, the pivot pin 65 of the hinge 47 is oriented generally perpendicular to the longitudinal axis of the handle 26. Accordingly, the hinge 47 allows the bracket 44 carrying the implement or tool 23 to pivot up and down relative to the bar 32, but limits rotation of the tool 23 so that the load 30 does not tip to one side or the other. To release or dump the load 30, the user steps off of the foot plate 41 and rotates the bar 32 relative to the bracket 44 such that the pivot pin 65 is generally parallel to the longitudinal axis of the handle 26. When the pivot pin 65 is parallel to the longitudinal axis, the load 30 can be dumped without lifting. The user simply twists the handle 26 and the second leaf 53 of the hinge 47 rotates outward to dump the load. After the load 30 is released, the user swivels the bar 32 back into the first position where the pivot pin 65 is generally perpendicular to the longitudinal axis of the shovel 23 and continues with the next load. The strap 118 may be connected anywhere to the device 20. The strap 118 may also be connected directly to the implement or tool 23. If the strap 118 is connected to one of the openings 67 on the hinge 47 that is located off center then the user can rotate the bar 32 to the dumping position by shifting their weight farther after stepping off of the foot plate 41 because the strap 118 will pull on one side of the bar 32 causing the bar 32 to rotate relative to the bracket 44.

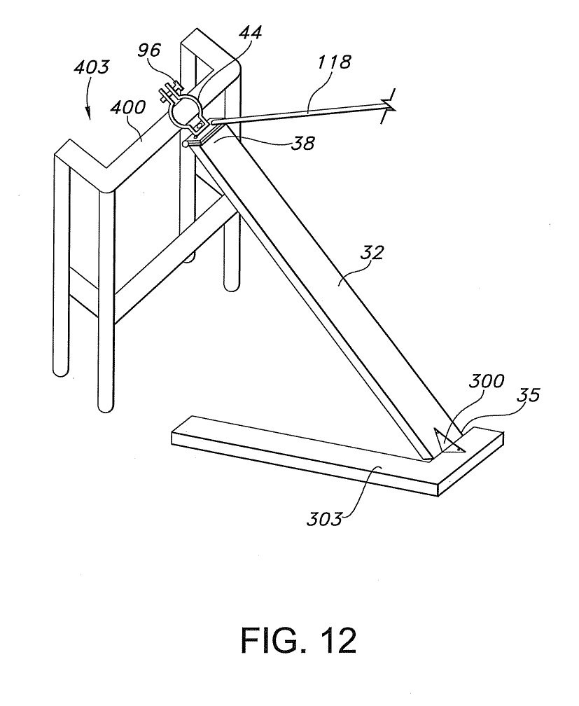

Turning to FIG. 12, the device of the present invention is shown in use with a different implement. The bracket 44 of the device is attached to a cross member 400 of a device 403 for assisting a disabled person. The device of the present invention may be used to assist with lifting the disabled person. In an example of use with another implement, the device shown in FIG. 12 could be used with a hand truck for lifting the hand truck to move a load up a set of stairs.

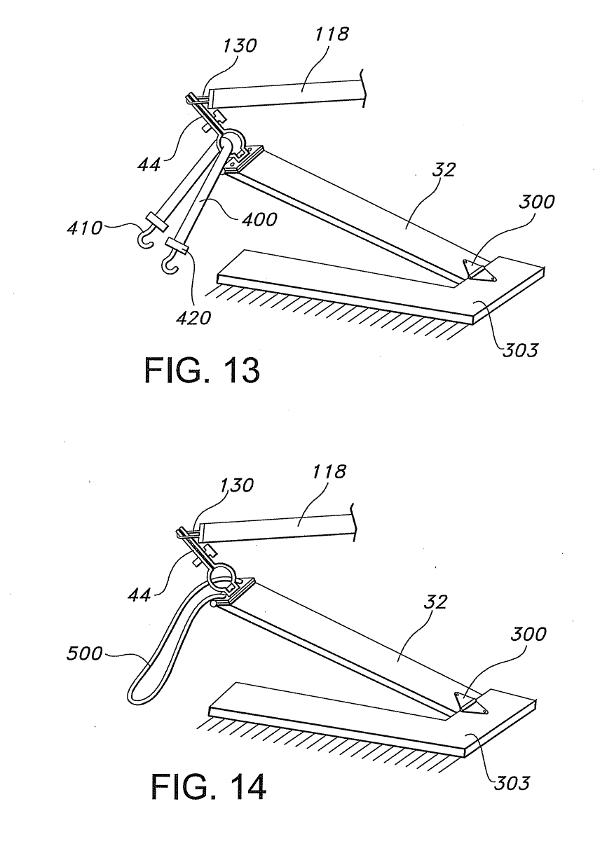

In FIGS. 13-14, the device is shown with a strap 400 having a pair of hooks 410, 420 for attaching a load, and the device is shown with a strap 500 forming a closed end loop for attaching a load. Use of the bar 32 in combination with the strap 118 mounted on the trunk or lower body of the user provides a mechanical advantage for lifting heavy objects.

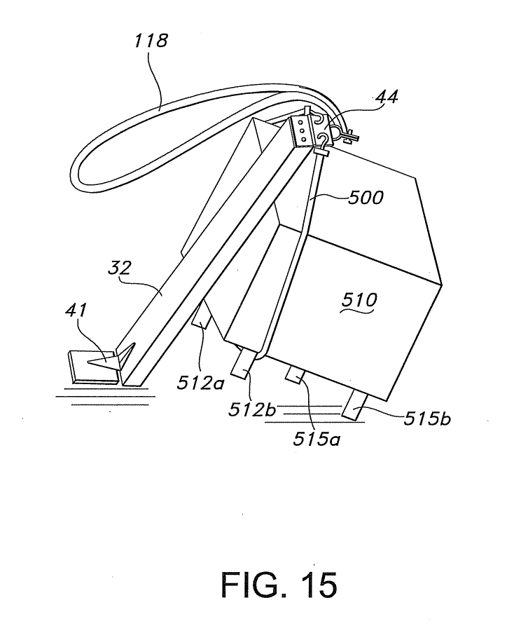

Turning to FIG. 15, an object 510 can be lifted and suspended above the support surface 520 by means of the device. The strap 500 is wrapped around the object 510 between the two pairs of legs 512a, 512b and 515a and 515b. The object 510 is lifted and moved toward the device. The device may then be positioned against the object 510 such that the object 510 is supported by the bar 32 by means of the strap 500 and is supported by the legs 515a, 515b. From this position, the strap 118 can be removed from the user and the object can be suspended above the support surface 525.

While the invention has been described in connection with certain embodiments, it is not intended to limit the scope of the invention to the particular forms set forth, but, on the contrary, it is intended to cover such alternatives, modifications, and equivalents as may be included within the spirit and scope of the invention as defined by the appended claims.

1. A lifting and moving device for assisting a user in applying a force to an implement, the lifting and moving device supported by a support surface, the lifting and moving device comprising:
a bar having a first end and a second end, the second end pivotally supported from the support surface;
the implement pivotally and rotatably attached to the first end of the bar;
a strap having a first portion capable of being attached to one of the device and the implement and having a second portion capable of being coupled to the user; and,
wherein movement of the user placing the strap under tension applies a force to the implement.

2. The device of claim 1, wherein the second portion of the strap is capable of being attached to one of the trunk and lower body of the user.

3. The device of claim 1, wherein the second portion of the strap is capable of being wrapped around one of the trunk and lower body of the user.

4. The device of claim 1, wherein a bracket supporting the implement is pivotally attached to the bar by a hinge.

5. The device of claim 4, wherein the bracket is rotatably attached to the hinge.

6. The device of claim 1, wherein the implement is a tool having an elongate handle.

7. The device of claim 5, wherein the hinge has a first leaf and a second leaf connected by a pivot pin.

8. The device of claim 7, wherein the hinge is rotatable relative to the tool between a first position where the pivot pin is generally perpendicular to a longitudinal axis of the handle and a second position where the pivot pin is generally parallel to a longitudinal axis of the handle.

9. The device of claim 8, wherein the strap is coupled to one of the bar and hinge such that pulling on the strap causes the hinge to rotate relative to the tool between the first position and the second position.

10. The device of claim 7, further comprising a foot plate extending from the bar, the foot plate disposed such that rotation of the bar about its longitudinal axis is substantially prevented when the user is pressing down on the foot plate.

11. The device of claim 1, further comprising a bracket supporting the implement, wherein the bracket has two halves capable of being connected around the implement.

12. A lifting and moving device for assisting a user in applying a force to a tool having an elongate handle, the device comprising:
a bar having a first end and a second end;
a hinge having a first leaf and a second leaf connected by a pivot pin, the first leaf attached to the first end of the bar; and,
a bracket rotatably attached to the second leaf of the hinge, the bracket configured to receive the handle of the tool.

13. The device of claim 12 further comprising a strap coupled to one of the device and the tool.

14. The device of claim 13, wherein the strap is capable of being attached to the user.

15. The device of claim 13, wherein the strap is capable of being wrapped around one of the trunk and lower body of the user.

16. The device of claim 12, further comprising a foot plate extending from the second end of the bar.

17. The device of claim 12, wherein the pivot pin is substantially aligned with an edge of the first end of the bar and the second leaf rotates outward relative to the bar.

18. The device of claim 12, wherein the bracket has two halves capable of being connected around the handle of the tool.

19. A lifting and moving device for assisting a user in applying a force to a tool having an elongate handle, the device comprising:
a bar having a first end and a second end;
a foot plate extending from the second end of the bar;
a hinge having a first leaf and a second leaf connected by a pivot pin, the first leaf attached to the first end of the bar;
a bracket rotatably attached to the second leaf of the hinge, the bracket configured to attach around the handle of the tool;
a strap having a first portion attached to one of the device and the tool and having a second portion capable of being coupled to the user;
wherein the hinge is rotatable relative to the tool between a first position where the pivot pin is generally perpendicular to a longitudinal axis of the handle and a second position where the pivot pin is generally parallel to a longitudinal axis of the handle.

20. The device of claim 19, wherein the strap is coupled to one of the bar and hinge such that pulling on the strap causes the hinge to rotate relative to the tool between the first position and the second position.

21. The device of claim 19, wherein the footplate is disposed such that rotation of the bar about its longitudinal axis is substantially prevented when the user is pressing down on the foot plate.

22-30. (canceled)

31. A lifting and moving device for assisting a user in applying a force to a tool, the device comprising:
a bar having a first end and a second end;
a hinge having a first leaf and a second leaf connected by a pivot pin, the first leaf attached to the first end of the bar; and,
the tool attached to the second leaf of the hinge.

32. A lifting and moving device for assisting a user in applying a force to an object, the lifting and moving device supported by a support surface, the lifting and moving device comprising:
a bar having a first end and a second end, the second end pivotally supported from the support surface;
the object connected to the first end of the bar;
a strap having a first portion capable of being attached to one of the device and the object and having a second portion capable of being coupled to the user; and,
wherein movement of the user placing the strap under tension applies a force to the object.

33. The device of claim 32 wherein the object is connected to the first end of the bar by a strap.
